(19) United States
(12) Patent Application Publication
(10) Pub. No.: US 2025/0347625 A1
(43) Pub. Date: Nov. 13, 2025

(54) APPARATUS AND METHOD FOR RAMAN OR FLUORESCENCE SPECTROSCOPY HAVING INSTANT POLARISATION ANALYSIS

(71) Applicant: HORIBA FRANCE SAS, PALAISEAU (FR)

(72) Inventor: Olivier ACHER, GIF SUR YVETTE (FR)

(21) Appl. No.: 18/866,694

(22) PCT Filed: May 17, 2023
(86) PCT No.: PCT/EP2023/063362

§ 371 Date: Nov. 18, 2024

(30) Foreign Application Priority Data
May 19, 2022 (FR) FR2204801

(51) Int. Cl. G01N 21/64; G01N 21/65

(52) U.S. Cl. CPC G01N 21/6445; G01N 21/6458; G01N 21/65; G01N 2021/6417

(57) ABSTRACT

The invention relates to an apparatus (100) and method for Raman, photoluminescence or fluorescence spectroscopy.

According to the invention, the apparatus comprises an optical device (16) for polarisation splitting and modification, comprising a polarization splitter (18) and a compensator (17), the optical device (16) being configured and oriented to split the incident light beam (20) emitted onto the diffraction grating (12) into a first part (21) of the emitted light beam that is polarised according to a first polarisation state and a second part (22) of the emitted light beam that is polarised according to a second polarisation state, and the detection system (13) being suitable for receiving, in a first detection area (14), a spectrum of the first part (21) of the emitted light beam and, simultaneously, in a second detection area (15), a spectrum of the second part (22) of the emitted light beam.

### TECHNICAL FIELD

The present invention relates to the technical field of optical spectrometry instruments and methods for analysing samples at a microscopic scale. In particular, the present invention relates to the Raman micro-spectrometry or fluorescence micro-spectrometry analysis and imaging techniques.

### Prior Art

In the above-mentioned field, the Raman confocal microscopy is well-known analysis and imaging technique described for example in “Raman Spectroscopy, Review”, Paul Rostron, Safa Gaber, Dina Gaber, International Journal of Engineering and Technical Research (IJETR) Vol. 6, N^{o} 1, p. 2454-4698 September 2016. Fluorescence microscopy has much in common with Raman microscopy.

In certain cases, Raman confocal microscopy uses a polarization analysis. Most of the polarization analyses useful in Raman microscopy consist in illuminating the sample with an excitation laser beam polarized according to a polarization state called laser polarization and analysing the Raman signal according to two polarization states: a polarization state identical to the laser polarization and the orthogonal polarization state.

According to the type of sample studied and the searched signal, Raman or fluorescence, the laser polarization state is generally either: linear along a fixed direction of the sample plane; linear along a direction of the sample plane chosen by the user, this direction being marked by an angle; right-hand or left-hand circular; axial, i.e. along the optical axis of the laser beam incident on the sample or also circumferential. It is noted that the axial and circumferential polarization states are orthogonal to each other. Likewise, the right-hand circular and left-hand circular polarization states are orthogonal to each other.

The analysis of the detected signal according to the polarization makes it possible to extract a quantity such as the degree of polarization, defined as the ratio between the intensity (I_parallel) of the Raman signal polarized according to the laser polarization and the total Raman intensity, according to the following formula: I_parallel/(I_perp+I_parallel), where I_perp represents the intensity of the Raman signal polarized orthogonally to the laser polarization. The intensity of the polarized Raman signal, I_parallel, and respectively I-perp, is measured as a function of the Raman wavelength to form a spectrum. A spectrum of the degree of polarization is thus obtained.

In case where the laser polarization is linear and adjustable in direction at an angle theta in the sample plane, the detected signal analysis according to the polarization makes it possible to extract the quantities I_parallel=f(theta), and respectively I_perp=f(theta), as a function of the angle theta and over the wavelength range of the Raman spectrum detected.

In a Raman micro-spectrometry apparatus, controlling the incident laser polarization and the analysis polarization is made complex by the presence of mirrors and/or filters on the laser beam path and the Raman signal path. However, it is conventional that the plane of incidence of the light beams on these mirrors and filters is vertical or horizontal. In this case, the polarization of a beam of horizontal or vertical linear polarization is unchanged during the beam transportation. On the contrary, the polarization of a beam of linear polarization oblique relative to the vertical and horizontal directions, or of elliptic polarization, is modified by the path of the incident laser beam and/or of the Raman beam. When the plane of incidence of the light beams on the path is horizontal, a horizontal linear polarization state is in the plane of incidence and a vertical polarization state is perpendicular to the plane of incidence. Conversely, when the plane of incidence of the light beams on the path is vertical, a vertical linear polarization state is in the plane of incidence and a horizontal polarization state is perpendicular to the plane of incidence.

There exist micro-spectrometry apparatuses adapted for the analysis according to various polarizations, without being affected by the polarization modifications liable to be introduced on the paths of the laser beam and/or the Raman beam. Such an apparatus generally uses an incident polarization of the laser switchable between a horizontal or vertical linear polarization, which is maintained from the laser source to the last deflecting mirror. A compensator, for example a wave plate, is located in the path common to the laser beam and to the backscattered Raman beam. This compensator is configured to transform the polarization of the laser light from a polarization maintained by the transport (horizontal or vertical) into a polarization of interest on the sample, such as for example a linear polarization oriented at an angle theta in the sample plane. The backscattered Raman beam that travels along the reverse path undergoes the reciprocal transformation. A fixed polarizer placed on the Raman path, out of the laser beam path, makes it possible to select one of the two polarization states not affected by the transportation (linear parallel or perpendicular).

For an analysis in circular polarization, according to the prior art, a quarter-wave plate is inserted on the common path. A co-polarization spectrum is obtained by acquiring the Raman spectrum when the polarizer is placed in the configuration parallel to the analysis polarization and the cross-polarization spectrum when the laser polarisation is placed in the configuration orthogonal to the analysis polarization. The ratio of these spectra (or the ratio between one of these spectra and the sum thereof) can be validly calculated, because they are obtained in directly comparable conditions of analysis of the Raman intensity.

To analyse the co-polarization and cross-polarization response, a solution consists in switching one of the polarizations (illumination or analysis) between parallel and perpendicular. However, switching the analysis polarization has a serious drawback, linked to the fact that, generally, the spectrometers have a response that varies greatly depending on whether the polarization is parallel or perpendicular. Indeed, the spectrometers generally include a diffraction grating. Now, the diffraction efficiency of a grating generally depends strongly on the orientation of the polarization with respect to the grating lines. It is therefore not possible to compare the intensities measured experimentally according to the parallel and perpendicular polarizations. A calibration of the spectral response of the spectrometer as a function of the polarization is complex. The use of a depolarizer, for example of the Lyot type, is imperfect and unsuitable for Raman spectrometry over a narrow spectral band.

One of the objects of the invention is to propose an enhancement to a Raman or, respectively, photoluminescence or fluorescence microscopy apparatus, making it possible to determine, with a single measurement, the Raman or, respectively, photoluminescence or fluorescence, response according to two polarization states orthogonal to each other, wherein the incident laser polarization can be linear according to an orientation of the plane chosen by the user, or circular, or circumferential in the plane, or axial along the optical axis of the objective.

Another object of the invention is to propose a Raman or, respectively, photoluminescence or fluorescence, microscopy apparatus and method making it possible to carry out an instantaneous and accurate measurement of the degree of polarization over the spectral range of the Raman or, respectively, photoluminescence or fluorescence, spectrum.

### Disclosure of the Invention

For that purpose, the invention relates to a Raman or photoluminescence or fluorescence spectrometry apparatus comprising a light source adapted to generate an excitation light beam incident on a sample, an optical system to collect and direct a light beam emitted by the sample towards an input of a spectrometer, the spectrometer comprising at least one diffraction grating and a detection system.

According to the invention, the apparatus comprises a polarization splitter and modifier optical device comprising a polarization splitter and a compensator, the optical device being located on a path of the emitted light beam out of the excitation light beam path, the optical device being configured and oriented to split the emitted light beam incident on the diffraction grating into a first part of the emitted light beam polarized according to a first polarization state and a second part of the emitted light beam polarized according to a second polarization state, the second polarization state being orthogonal to the first polarization state, said first and second polarization states being chosen among polarization states having a component S1 of their Stokes vector less than or equal to 0.2 in absolute value and the detection system being adapted to receive, on a first detection area, a spectrum of the first part of the emitted light beam polarized according to the first polarization state and simultaneously, on an second detection area, a spectrum of the second part of the emitted light beam polarized according to the second polarization state, the first area and the second area being separated along a direction transverse to a direction of spectral diffraction on the detection system.

According to a particular and advantageous aspect, the polarization splitter is located on the path of the emitted light beam downstream from the compensator.

According to another particular and advantageous aspect, the polarization splitter is located on the path of the emitted light beam upstream from the compensator and the compensator has a Mueller matrix with an element M1,1 less than 0.2 in absolute value over a spectral range of detection.

According to an exemplary embodiment, the polarization splitter is adapted to laterally split the emitted light beam to form the first part of the emitted light beam and, respectively, the second part of the emitted light beam.

For example, the polarization splitter comprises a birefringent plate or a Savart plate.

According to an exemplary embodiment, the polarization splitter is adapted to angularly split the emitted light beam to form the first part of the emitted light beam and, respectively, the second part of the emitted light beam.

For example, the polarization splitter comprises a Wollaston prism, a Rochon prism or a Nomarski prism.

According to a particular and advantageous aspect, the compensator comprises a half-wave plate oriented so that said first polarization state is linear inclined at −45 degrees relative to the diffraction grating lines and the second linear polarization state inclined at +45 degrees relative to the diffraction grating lines, or the compensator comprises a quarter-wave plate oriented so that said first polarization state is right-hand circular and the second polarisation state is left-hand circular or the compensator comprises a Fresnel rhombohedron.

Advantageously, the compensator has an achromatic retardance on the spectrum of the first part of the emitted light beam, and respectively on the spectrum of the second part of the emitted light beam.

According to various embodiments, the polarization splitter and modifier optical device is located in the spectrometer between the spectrometer input and the at least one diffraction grating, or the polarization splitter and modifier optical device is located in a converging part of the emitted light beam upstream from the spectrometer input or the polarization splitter is located in a collimated part of the emitted light beam upstream from the spectrometer input. Advantageously, in this case, the compensator is located downstream from the polarization splitter, the compensator being located between the last optical component liable to modify the polarisation of the emitted light beam on the collimated path and the diffraction grating.

Advantageously, the polarization splitter and modifier optical device can be retracted out of the emitted light beam and the apparatus comprises an optical component adapted to be inserted on the path of the emitted light beam to compensate for a defocusing of the emitted light beam at the input of the spectrometer or on the detection system of the spectrometer, when the polarization splitter and modifier optical device is retracted.

According to a particular and advantageous aspect, the apparatus comprises an optical retarder placed on a path that is common to the emitted light beam and the excitation light beam, the optical retarder having an optical retardance and being oriented so as to adjust at least one polarization state of the excitation light beam incident on the sample.

For example, the optical retarder comprises a quarter-wave plate, a half-wave plate, a Fresnel rhombohedron, a birefringent plate having an adjustable retardance or a pixelated optical retarder having a spatially adjustable retardance.

According to a particular aspect, the apparatus comprises a calculator adapted to calculate a degree of polarization as a function of the spectrum of the first part of the emitted light beam polarized according to the first polarization state and of the spectrum of the second part of the emitted light beam polarized according to the second polarization state.

The invention also relates to a Raman or photoluminescence or fluorescence spectrometry method comprising the following steps:
generating and directing an excitation light beam incident on a sample,
collecting and directing a light beam emitted by the sample to an input of a spectrometer comprising at least one diffraction grating and a detection system,
splitting and modifying the polarization of the emitted light beam on an optical path out of the path of the excitation light beam, so as to split the emitted light beam incident on the diffraction grating into a first part of the emitted light beam polarized according to a first polarization state and a second part of the emitted light beam polarized according to a second polarization state, the second polarization state being orthogonal to the first polarization state, said first and second polarization states being chosen among polarization states having a component S1 of their Stokes vector less than or equal to 0.2 in absolute value and
acquiring, on a first detection area of the detection system, a spectrum of the first part of the emitted light beam polarized according to the first polarization state and simultaneously acquiring, on an second detection area, a spectrum of the second part of the emitted light beam polarized according to the second polarization state, the first area and the second area being separated along a direction transverse to a direction of spectral diffraction on the detection system.

Obviously, the different features, alternatives and embodiments of the invention can be associated with each other according to various combinations, insofar as they are not incompatible or exclusive with respect to each other.

### BRIEF DESCRIPTION OF THE DRAWINGS

Moreover, various other features of the invention emerge from the appended description made with reference to the drawings that illustrate non-limiting embodiments of the invention, and wherein:

FIG. 1 is a schematic view of a Raman or photoluminescence or fluorescence spectrometry apparatus according to the present disclosure,

FIG. 2 is a schematic view of a polarization splitter and modifier optical device according to a first exemplary embodiment,

FIG. 3 is a schematic view of a polarization splitter and modifier optical device according to a second exemplary embodiment,

FIG. 4 is a schematic view of a polarization splitter and modifier optical device according to a third exemplary embodiment.

It is to be noted that, in these figures, the structural and/or functional elements common to the different alternatives can have the same references numbers.

### DETAILED DESCRIPTION

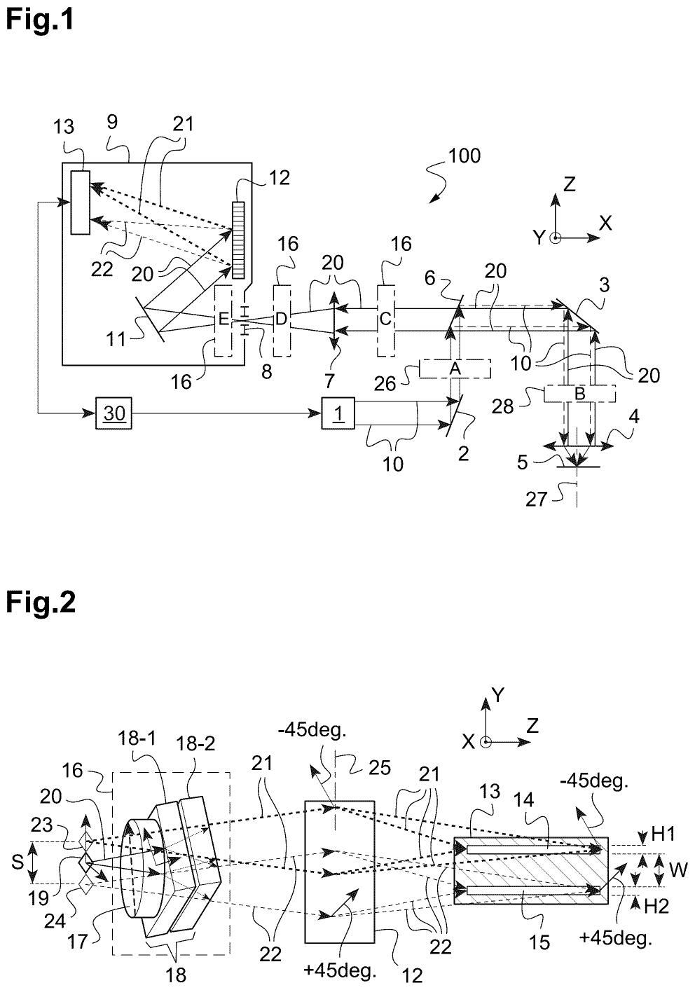

In FIG. 1, the spectrometry apparatus 100 comprises a light source 1, an optical system comprising mirrors 2, 3 and a microscope objective 4, a filter 6, an optical focusing system 7 and a spectrometer 9. The spectrometer 9 comprises an input 8 (for example, of the slit or hole type), at least one diffraction grating 12 and a detection system 13. In the example shown in FIG. 1, the spectrometer 9 also comprises a mirror 11. The spectrometry apparatus 100 comprises a calculator 30. According to the present disclosure, the spectrometry apparatus 100 includes a polarization splitter and modifier optical device 16. Optionally, the spectrometry apparatus 100 includes an optical retarder 28. According to an alternative, the apparatus 100 comprises a confocal opening placed in an image plane of the sample between the microscope objective 4 and the spectrometer input 8 to spatially filter the detected signal.

The operation of the spectrometry apparatus 100 will now be described. An orthonormal reference frame XYZ has been shown. In the example of FIG. 1, a sample 5 is placed in a horizontal XY-plane, the normal to the surface of the sample 5 being vertical. The light source 1 comprises for example a laser that emits an excitation light beam 10. The excitation light beam 10 has a specified wavelength, denoted lambda, for example of 532 nm. Advantageously, the excitation light beam 10 is polarized according to a linear polarization state parallel or perpendicular to the plane of FIG. 1. In certain cases, the light source 1 emits a polarized beam, generally linearly. As an option, the apparatus comprises a polarizer 26 placed on the path of the excitation light beam 10 to linearly polarize the excitation light beam 10 or to orient the polarization state of the excitation light beam 10, preferably parallel or perpendicular to the plane of FIG. 1.

The optical system with mirrors 2, 3 and the filter 6 are arranged so as to direct the excitation light beam 10 towards the microscope objective 4. The optical system with mirrors 2, 3, the filter 6 and the microscope objective 4 are arranged so as to maintain the polarization state of the excitation light beam 10 between the light source 1, possibly associated with the polarizer 26, and the sample 5. For that purpose, the normal to the mirrors 2, 3 and to the filter 6 and the optical axis of the microscope objective 4 are in the plane of incidence. Therefore, the polarization state of the excitation light beam 10 is not affected by the transportation of the excitation light beam 10 via the optical system with mirrors 2, 3, the filter 6 and the microscope objective 4. The microscope objective 4 focuses the excitation laser beam 10 to a point of the sample 5. Advantageously, the optical axis 27 of the microscope objective 4 is parallel to the normal to the surface of the sample 5 at the illuminated point. That way, the excitation light beam 10 incident on the sample 5 is polarized with a determined linear polarization.

Optionally, the spectrometry apparatus 100 includes an optical retarder 28 located between the last mirror 3 and the microscope objective 4. The operation of this optional optical retarder 28 is described in detail hereinafter in the present disclosure. First will be described the operation of the Raman or fluorescence spectrometry apparatus in the absence of the optical retarder 28.

In response to the excitation light beam 10, the sample 5 emits an emitted light beam 20 by Raman or photoluminescence (PL) or fluorescence effect in a spectral domain that is different from the wavelength of the excitation light beam.

The spectrometry apparatus 100 shown in FIG. 1 is in a backscattering configuration. The optical axis of the excitation light beam 10 incident on the sample 5 is parallel to the normal to the surface of the sample 5 at the illuminated point. The backscattered emitted light beam 20 propagates in the opposite direction to the excitation light beam 10. In other words, the excitation light beam 10 and the emitted light beam 20 have a part of the optical path in common between the sample 5 and the filter 6. The excitation light beam 10 and the emitted light beam 20 generally have the same polarization state, for example linear parallel or perpendicular to the plane of FIG. 1.

The filter 6 makes it possible to split the emitted light beam 20 by Raman or PL or fluorescence effect from a Rayleigh beam formed by reflection on a sample at the laser wavelength lambda. Filter 6 is for example an injection-rejection filter or an injector-rejector filter. Filter 6 comprises for example a notch filter that transmits the Raman or PL or fluorescence emitted light beam 20, while reflecting the Rayleigh beam in a narrow spectral band around the laser wavelength.

The optical focusing system 7 receives the emitted light beam 20 and focuses this beam to the input 8 of the spectrometer 9. Advantageously, the microscope objective 4, the mirror 3, the filter 6 and the optical focusing system 7 are arranged and configured so as to maintain the polarization state of the Raman or PL or fluorescence emitted light beam 20 when this polarization state is linear vertical (along X or Z) or horizontal (along Y).

As indicated, the considered spectrometer 9 is of the diffraction grating type. The spectrometer comprises for example a flat diffraction grating 12. As an alternative, in a well-known way, the spectrometer comprises several diffraction gratings, for example two or three diffraction gratings mounted on a turret to be used one by one. Each diffraction grating is adapted to a particular spectral domain, so that a diffraction grating can be selected for the analysis in the corresponding particular spectral domain. The spectrometer includes for example a mirror 11 that deflects the emitted light beam 20 towards the diffraction grating 12. The diffraction grating 12 diffracts the emitted light beam 20 as a function of the wavelength in order to form a spectrum on the detection system 13. The mirror 11 and the diffraction grating 12 are configured to form a spectral image of the input 8 of the spectrometer 9 on the detection system 13. The detection system 13 comprises a two-directions spatially resolved imaging detector, such as, for example, a CCD-type pixel-matrix detector.

The diffraction grating 12 of the spectrometer 9 is configured so that the grating lines are substantially aligned along a direction 25 that is here perpendicular to the plane of FIG. 1.

According to the present disclosure, the spectrometry apparatus 100 includes a polarization splitter and modifier optical device 16 located on the path of the emitted light beam 20 (Raman, PL or fluorescence) out of the path of the excitation light beam 10. Generally, the polarization splitter and modifier optical device 16 comprises a polarization splitter 18 and a compensator 17 arranged in series on the path of the emitted light beam 20. According to various exemplary embodiments, the polarization splitter 18 is located upstream or downstream from the compensator 17. FIG. 1 illustrates various possible locations of the polarization splitter and modifier optical device 16, these locations being denoted with letters C, D or E, respectively. However, a single polarization splitter and modifier optical device 16 is used.

According to a first embodiment, the polarization splitter and modifier optical device 16 is located inside the spectrometer 9, between the spectrometer input and the diffraction grating 12 (location denoted by letter E in FIG. 1). In this case, the optical device 16 is inserted on a part of the path of the emitted light beam 20 where this beam is divergent. Various alternatives of this first embodiment will now be described in connection with FIGS. 2 to 4.

FIG. 2 illustrates a first exemplary embodiment in which the polarization splitter and modifier optical device 16 is placed inside the spectrometer 9. The elements of the apparatus 100 other than the spectrometer are similar to those described in connection with FIG. 1. That way, only the part relating to the spectrometer is shown in FIG. 2. In this example, the compensator 17 comprises a wave plate and the polarization splitter 18 comprises a Savart plate. The compensator 17 is here placed upstream from the polarization splitter 18. More precisely, the compensator 17 is here a half-wave plate. Advantageously, the half-wave plate 17 is achromatic, i.e. it has a half-wave optical retardance on a spectral domain containing the studied Raman or PL or fluorescence wavelength interval. As known, the Savart plate is formed of a first plate 18-1 joined to a second plate 18-2.

The optical focusing system 7 focuses the emitted light beam 20 (Raman or PL or fluorescence) into a spot 19 at the input 8 of the spectrometer 9. The axis 25 of the diffraction grating 12 lines is for example arranged vertically. Generally, the emitted light beam 20 comprises a linear polarization component parallel to the axis 25 of the diffraction grating 12 lines and a linear polarization component perpendicular to the axis 25 of the diffraction grating 12 lines. These two polarization components are represented by arrows at the spot 19 on FIG. 2. The apparatus 100 is configured so that these two polarization components are transported without being modified by the optical components between the last mirror 3 and the input of the spectrometer 9. In this first example, the half-wave plate 17 is oriented with an angle of 22.5 degrees relative to the axis 25 of the diffraction grating 12 lines or relative to an axis perpendicular to the axis 25 of the diffraction grating 12 lines. The half-wave plate 17 receives the emitted light beam 20 and rotates its polarization components by 2×22.5 degrees, i.e. 45 degrees. Therefore, the linear polarization component parallel to the axis 25 remains of linear polarization but oriented at +45 degrees from the axis 25 of the diffraction grating 12 lines. Likewise, the linear polarization component perpendicular to the axis 25 remains of linear polarization but oriented at −45 degrees from the axis 25 of the diffraction grating 12 lines. As known, the Savart plate makes it possible to laterally split the linear polarization component oriented at +45 degrees from the linear polarization component oriented at −45 degrees. The Savart plate 18 transforms the spot 19 located at the spectrometer input into two virtual spots 23 and 24, each associated with a different polarization component. Moreover, the Savart plate is oriented so that the two virtual spots 23 and 24 are separated from each other in the direction parallel to the axis 25 of the grating 12 lines. At the Savart plate output, a first part 21 of the emitted light beam linearly polarized at −45 degrees and a second part 22 of the emitted light beam linearly polarized at +45 degrees are obtained. The first part 21 of the emitted light beam and the second part 22 of the emitted light beam propagate parallel to each other towards the diffraction grating 12. The distance S between the first part 21 of the emitted light beam and the second part 22 of the emitted light beam is determined by construction by the Savart plate. The distance S is equal to the distance between the two virtual spots 23 and 24.

The diffraction grating 12 receives simultaneously the first part 21 of the emitted light beam linearly polarized at −45 degrees and the second part 22 of the emitted light beam linearly polarized at +45 degrees. The diffraction grating 12 diffracts, as a function of the wavelength, the first part 21 of the emitted light beam linearly polarized at −45 degrees and the second part 22 of the emitted light beam linearly polarized at +45 degrees, while maintaining the lateral split between these two beams. The advantage to use components of linear polarizations at −45 deg. and +45 deg. is that these polarization states are insensitive to the anisotropy of the diffraction grating 12. Therefore, these two polarization components are diffracted on the diffraction grating 12 with an equal diffraction efficiency, even if they are not incident on the same areas of the diffraction grating 12. That way, the spectrometer 9 does not modify the ratio between the linear polarization components at −45 deg. and +45 deg.

The spectrometer 9 forms a spectral image (or spectrum) of the first part 21 of the emitted light beam linearly polarized at −45 degrees on a first area 14 of the detection system 13. Simultaneously, the spectrometer 9 forms a spectral image (or spectrum) of the second part 22 of the emitted light beam linearly polarized at +45 degrees on a second area 15 of the detection system 13. These two spectra are separated on the detection system by a distance W in a direction parallel to the axis 25 of the diffraction grating 12 lines. The width at half height in intensity of the spectrum of the first part 21, respectively the second part 22, of the emitted light beam in direction transverse to the spectrum diffraction direction is denoted H1, respectively H2. Advantageously, the Savart plate is configured so that the distance W between the two spectra is greater than the width at half height H1, respectively H2. The distance W is here equal to S. That way, the detection system 13 acquires simultaneously a spectrum of the first part 21 of the emitted light beam linearly polarized at −45 degrees and a spectrum of the second part 22 of the emitted light beam linearly polarized at +45 degrees. Therefore, the two spectra can be acquired on a same detection system 13, for example of the imaging detector type, as illustrated in FIG. 2. As an alternative, two linear array detectors are used, arranged parallel to each other, a linear array being adapted to detect the first part 21 of the emitted light beam and the other linear array being adapted to detect the second part 22 of the emitted light beam.

The two spectra are transmitted to the calculator 30. The calculator 30 is configured to display these two spectra, or also to calculate a ratio between the spectrum of the first part 21 of the emitted light beam linearly polarized at −45 degrees according to the first polarization state and the spectrum of the second part 22 of the emitted light beam linearly polarized at +45 degrees. From these two spectra, the calculator 30 can also deduce the degree of polarization of the emitted light beam relative to the component linearly polarized at −45 degrees or +45 degrees. The polarization degree is equal to the difference in intensity of the two polarization components divided by the sum of these intensities. The Raman or fluorescence micro-spectrometry apparatus 100 thus enables an instantaneous polarization analysis of the detected spectra.

Advantageously, the polarization splitter and modifier optical device 16 is retractable. The fact to remove the optical device 16 from the optical path has for effect to modify the focusing of the spectra on the pixelated sensor, which is liable to deteriorate the spectral resolution of the spectrometer 9. Also, according to an alternative embodiment of the invention, it is provided to insert an optical component, of the lens or meniscus type, to compensate for the defocusing of the spectra when the optical device 16 is retracted. Advantageously, such a focusing-corrector optical component is placed on a sliding plate-holder integral with the optical device 16, so as to place on the optical path either the optical device 16 or the focusing-corrector optical component.

An example of polarization splitter and modifier optical device 16 placed inside the spectrometer as illustrated in FIG. 2 is given here. A Savart plate made of alpha-BBO (or alpha barium borate), of total thickness 16 mm and cross-section 8×8 mm² is used. A broad spectral band half-wave plate 17 is placed at a distance of 1 mm upstream from the Savart plate 18. The half-wave plate 17 is oriented so that its eigen-axis is at 22.5 degrees from the eigen-axes of the diffraction grating. The Savart plate is oriented in such a way as to make a lateral separation parallel to the grating lines. The back-focus position of the CCD detector is readjusted by 4 to 5 mm to correct a slight focusing error introduced by the Savart plate 18. Two spectra spaced apart by a distance W of about 1.1 mm are obtained on the CCD detector.

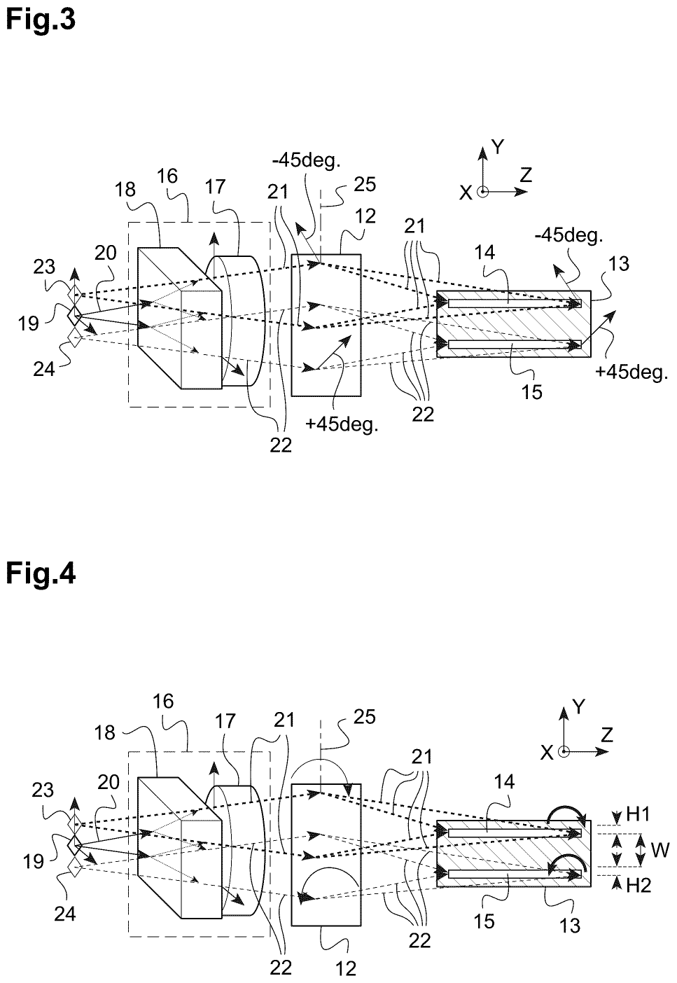

FIG. 3 illustrates a second exemplary embodiment in which the polarization splitter and modifier optical device 16 is also placed inside the spectrometer 9. In this second exemplary embodiment, the polarization splitter 18 is consisted of an anisotropic crystalline material, cut along specific directions, and the compensator 17 is consisted of a half-wave plate, preferably achromatic. The compensator 17 is here placed downstream from the polarization splitter 18. The polarization splitter 18 is configured and oriented so that the linear polarization components parallel and perpendicular to the axis 25 of the diffraction grating 12 lines are eigen-polarizations of the polarization splitter 18. In other words, the polarization splitter 18 does not modify the linear polarization components parallel and perpendicular to the axis 25, but splits them laterally. At the input 8 of the spectrometer, two virtual spots 23 and 24 are thus obtained, separated along an axis parallel to the axis 25 of the grating lines. As in the first example, the half-wave plate 17 transforms the linear polarization component parallel, respectively perpendicular, to the axis 25 into a linear polarization component at −45 degrees, respectively +45 degrees, relative to the axis 25 of the grating lines.

As in the example illustrated in FIG. 2, the polarization splitter and modifier optical device 16 thus makes it possible to illuminate the diffraction grating 12 with a first part 21 of the emitted light beam linearly polarized at −45 degrees and a second part 22 of the emitted light beam linearly polarized at +45 degrees. And the detection system 13 acquires simultaneously a spectrum of the first part 21 of the emitted light beam linearly polarized at −45 degrees on a first detection area 14 and a spectrum of the second part 22 of the emitted light beam linearly polarized at +45 degrees on a second detection area 15. The first detection area 14 and the second detection area 15 are separated by a distance W.

By way of example, the apparatus 100 is a Raman microscope comprising a spectrometer 9 of focal length 300 mm and using a laser source emitting at the wavelength of 532 nm. A polarization splitter and modifier optical device 16 is added inside the spectrometer as illustrated in FIG. 3. The polarization splitter 18 is a calcite crystal with a thickness of 10 mm and a cross-section of 8×8 mm². Downstream from the polarization splitter 18, at a distance of 1 mm, is placed a compensator 17 consisted of a broad spectral band half-wave plate an eigen-axis of which is oriented at 22.5 degrees from the eigen-axes of the diffraction grating. A lens of focal length F=500 mm made of a material N-BK7, at a distance of 60 mm from the spectrometer input hole, is added in order to correct a slight lack of sharpness introduced by the splitter. Two spectra, spaced by about W=0.9 mm, are obtained on the CCD detector, the first spectrum relating to the linear polarization at −45 deg., and the second spectrum relating to the linear polarization at +45 deg. The width at half height H1, H2 of each spectrum is not affected by the polarization splitting.

FIG. 4 illustrates a third exemplary embodiment in which the polarization splitter and modifier optical device 16 is also placed inside the spectrometer 9. In this third exemplary embodiment, the polarization splitter 18 is consisted of an anisotropic crystalline material, cut along specific directions, and the compensator 17 is consisted of a quarter-wave plate, preferably achromatic. The compensator 17 is here placed downstream from the polarization splitter 18. As an alternative, the polarization splitter 18 is consisted of a Savart plate. The polarization splitter 18 is configured and oriented so that the linear polarization components parallel and perpendicular to the axis 25 of the diffraction grating 12 lines are eigen-polarizations of the polarization splitter 18. In other words, the polarization splitter 18 does not modify the linear polarization components parallel and perpendicular to the axis 25, but split them laterally. At the input 8 of the spectrometer, two virtual spots 23 and 24 are thus obtained, separated along an axis parallel to the axis 25 of the grating lines. Unlike the first two examples, the quarter-wave plate 17 here transforms the linear polarization component parallel, and respectively perpendicular, to the axis 25 of the grating lines into a right-hand circular, and respectively left-hand circular, polarization component on the diffraction grating 12 (represented by curvilinear arrows in FIG. 4). In this third embodiment, the polarization splitter and modifier optical device 16 makes it possible to illuminate the diffraction grating 12 with a first part 21 of the emitted light beam of right-hand circular polarization and a second part 22 of the emitted light beam of left-hand circular polarization. The advantage to use components of right-hand circular and left-hand circular polarization is that these circular polarization states are insensitive to the anisotropy of the diffraction grating 12. Therefore, these two right-hand circular and left-hand circular polarization components are diffracted on the diffraction grating 12 with a same diffraction efficiency.

The spectrometer 9 forms a spectral image of the first part 21 of the emitted light beam of right-hand circular polarization on a first area 14 of the detection system 13. Simultaneously, the spectrometer 9 forms a spectral image of the second part 22 of the emitted light beam of left-hand circular polarization on a second area 15 of the detection system 13. These two spectra are separated on the detection system by a distance W in a direction parallel to the axis 25 of the diffraction grating 12 lines. That way, the detection system 13 acquires simultaneously a spectrum of the first part 21 of the emitted light beam of right-hand circular polarization and a spectrum of the second part 22 of the emitted light beam of left-hand circular polarization.

According to a second embodiment, the polarization splitter and modifier optical device 16 is located outside the spectrometer 9, between the optical focusing system 7 and the spectrometer input 8 (location denoted by letter D in FIG. 1). In this case, the optical device 16 is inserted on a part of the path of the emitted light beam 20, Raman or PL or fluorescence, where this beam is convergent. The optical device 16 can be consisted of a wave plate 17 and a Savart plate 18, as described in connection with FIG. 2, or of a polarization splitter 18 and a wave plate as described in connection with FIG. 3 or FIG. 4. In this second embodiment, the polarization splitter and modifier optical device 16 generates two real spots 23, 24 at the input 8 of the spectrometer. The optical device 16 is configured so that the two real spots 23, 24 are arranged along a direction parallel to the axis 25 of the diffraction grating lines. The shape of the spatial filter at the spectrometer input 8 is adapted to allow the two real spots 23, 24 to enter the spectrometer 9, to be diffracted on the diffraction grating 12 to form two split spectra on the detection system. A slit-type spatial filter is rather used in this case. The two spectra have polarization states that are orthogonal to each other. According to the type of polarization splitter and modifier optical device 16 used, the two real spots 23, 24 and the corresponding spectra thereof are linearly polarized at ±45 deg. or circularly polarized. In the case of a polarization splitter and modifier optical device 16 similar to that described in connection with FIG. 2 or 3, the two real spots 23, 24 and the corresponding spectra thereof have linear polarizations at −45 deg. and +45 deg., respectively. In the case of a polarization splitter and modifier optical device 16 similar to that described in connection with FIG. 2 or 3, the two real spots 23, 24 and the corresponding spectra thereof have right-hand circular and left-hand circular polarization, respectively.

According to a third embodiment, the polarization splitter and modifier optical device 16 is located outside the spectrometer 9. The polarization splitter 18 is here chosen and configured to angularly split two orthogonal polarization sates, for example a linear polarization state parallel and a linear polarization state perpendicular to the axis 25 of the grating 12 lines. In this case, the polarization splitter 18 is inserted on a part of the path of the emitted light beam 20, Raman or PL or fluorescence, where this beam is collimated (location denoted by letter C in FIG. 1). The polarization splitter 18 is for example located between the injection-rejection filter 6 and the optical focusing system 7 on the input 8 of the spectrometer 9. The splitting angle of the polarization splitter 18 is denoted alpha and the focal length of the optical focusing system 7 is denoted F. The polarization splitter 18 comprises a Wollaston prism, a Rochon prism or a Nomarski prism. The polarization splitter 18 thus makes it possible to generate two real spots 23, 24 at the input 8 of the spectrometer 9, having mutually orthogonal polarization states. The splitting angle alpha is chosen so that the product alpha. F is higher than the width at half height, H1, H2, of a spectrum on the detection system 13 of the spectrometer 9. The polarization splitter 18 is oriented so that the two real spots 23 and 24 are separated from each other in a direction parallel to the axis 25 of the grating lines.

In the third embodiment, the compensator 17 comprises a wave plate. The compensator 17 is located downstream from the polarization splitter 18. For example, the compensator 17 comprises a quarter-wave plate oriented at 45 degrees relative to the axis 25 of the grating lines or a half-wave plate oriented at 22.5 degrees relative to the axis 25 of the grating lines or a transverse axis.

In the third embodiment, the compensator 17 is arranged between the last optical component liable to modify the polarization of the emitted light beam on the collimated path, such as a mirror or a filter 6, and the diffraction grating 12, i.e. at the location denoted by letter C, D or E in FIG. 1. This arrangement enables to transform the linear polarization states parallel and perpendicular to the axis of the grating lines into right-hand and left-hand circular polarization states or into linear polarization states inclined by ±45 deg. relative to the axis 25 of the grating 12 lines and to split these orthogonal polarization states on the detection system 13.

As an alternative of the third embodiment, the compensator 17 comprises a Fresnel rhombohedron placed on a part of the path of the emitted light beam 20 (Raman or PL or fluorescence), where this beam is collimated (location denoted by letter C in FIG. 1). The Fresnel rhombohedron is here configured to show the retardance of a half-wave or quarter-wave plate. Such a Fresnel rhombohedron has for advantage to show a constant retardance over a wide range of wavelengths. A Fresnel rhombohedron constitutes a high-performance alternative, less expensive than an achromatic wave plate.

A half-wave plate oriented at 22.5 degrees, or a quarter-wave plate oriented at 45 degrees, are examples of compensator 17 adapted to transform the polarization states at the polarization splitter output into other polarization states insensitive to the anisotropy effects of the diffraction grating. More generally, a compensator 17 adapted to be placed after the polarization splitter 18 comprises a plate that has a Mueller matrix, the element M1,1 of which is close to 0. More precisely, the absolute value of the element M1,1 of the Mueller matrix of the compensator 17 is less than 0.2, or preferably less than 0.1. That is to say that, if at the input of the compensator 17, IV-IH^{o}=1, at the output of the compensator 17, IV-IH ^{˜}0, where IV-IH is the difference between the vertically polarized component (along V) and the horizontally polarized component (along H) of the light intensity. In other words, the component S1 of the Stokes vector of the beams at the output of the compensator 17 is close to zero. In the present document, the element M1,1 of the Mueller matrix is denoted M11. Likewise, the element M1,2 of the Mueller matrix is denoted M12, and the element M1,3 of the Mueller matrix is denoted M13.

In other words, the compensator 17 placed after the polarization splitter 18 has for function to transform the polarization of the two split beams, for example into a horizontal linear polarization component (H) and a vertical linear polarization component (V), into two polarized beams for which the diffraction efficiency of the diffraction grating 12 is identical. The transformations into two circular waves (left-hand and right-hand) or into two linear waves at +45 deg. and −45 deg. are only two examples of transformations enabling to obtain this result. In the general case, it is useful to describe the properties of the compensator 17 by certain properties of its Mueller matrix. The Mueller matrix enables to fully describe the polarization transformations provided by a component to an incident beam. The polarization properties of a beam are fully described by their Stokes vector (see for example the publication R.M.A. Azzam, “Stokes-vector and Mueller-matrix polarimetry”, JOSA A, col 33, p 1396, 2016). The Mueller matrix of a component can be determined experimentally using instruments commonly called Muller-meter or Mueller-ellipsometer. A compensator 17 can be defined by the properties of its Mueller matrix, both from the theoretical and the experimental points of view.

The use in a polarization splitter and modifier optical device 16 according to the invention of a compensator 17 having a Mueller matrix whose element M1,1 is less, in absolute value, than 0.2 and preferably less than 0.1, makes it possible to transform the polarization splitter beams, respectively V and H, at the polarization splitter output (i.e. with a component of the Stokes vector having the respective values S1=+1 and S1=−1), into two beams whose component S1 is less, in absolute value, than 0.2, and respectively less than 0.1. This condition is sufficient to establish that two beams are diffracted with the same efficiency by the diffraction grating 12.

The required property for the compensator 17 located after the polarization splitter 18 is then that the element M1,1 of its Mueller matrix is zero or at least less than 0.2, and preferably less than 0.1. A quarter-wave plate oriented at 45 deg., or a half-wave plate oriented at 22.5 deg., are examples of compensators verifying the property M1,1=0. In the case of a microscope operating with several laser wavelengths, and hence several Raman (of photoluminescence or fluorescence) wavelength ranges, the condition on the element M11≤0.2 in absolute value (and preferably M11≤0.1) of the Mueller matrix is less limiting than a constraint over a broad spectral band quarter-wave plate or over a broad spectral band half-wave plate. The use of a compensator having a matrix M1,1 close to 0 is appreciable because it makes it possible, with lesser cost and complexity, to obtain the same diffraction efficiency on the diffraction network over the spectral band of interest.

Another example of compensator having an element M1,1 in its Mueller matrix close to zero on a broad spectral band will now be described. In practice, a compensator is chosen, whose Mueller matrix has an element M1,1 less, in absolute value, than 0.2, and preferably than 0.1, on a broad spectral band. The compensator 17 is made by putting in series two half-wave plates at 540 nm, the first half-wave plate being oriented at 15 degrees from the vertical, the second half-wave plate being oriented at 35 degrees from the vertical, in the order in which the emitted light beam 20 passes through the compensator 17 on face A, the opposite face being face B. When this compensator 17 is illuminated on its face A with a light polarized in such a manner that its reduced Stokes vector (1,0,0), i.e. with a horizontal linear polarization, the output Stokes vector, which is (M11; M12; M13) has been determined experimentally. It is observed that the output Stokes vector has a component M11 almost null, with M11 less than 0.1 on the spectral band extending from 400 nm to 1000 nm. At the wavelengths close to 530 nm, the component acts almost as a half-wave plate oriented at 22.5°, the horizontal linear polarization is transformed into a linear polarization at 45°, and M11=0, Abs(M12)=1, and M13=0. On the other hand, at 425 nm and around 725 nm, the behaviour is close to a quarter-wave plate oriented at 45 deg., because the output Stokes vector is approximately that of a circular polarization, Abs(M13)=1, and M11=M12=0. Between the wavelengths 425 nm and 725 nm, the horizontal polarization is transformed into various elliptic polarizations, the equivalent behaviour of the component is not that of a half-wave or quarter-wave plate. When this compensator 17 is illuminated on its face B with a light polarized in such a way that its reduced Stokes vector (1,0,0), i.e. with a horizontal linear polarization, the output Stokes vector, which is (M11; M12; M13) is determined experimentally. It is observed that the property M11 close to zero is verified, with Abs(M11) less than 0.1 over a broad spectral range from 400 nm to 1000 nm. However, the output polarization strongly depends on the wavelength.

As indicated hereinabove, the spectrometry apparatus 100 includes as an option an optical retarder 28 located between the last mirror 3 and the microscope objective 4 on a part of path common to the excitation light beam and the emitted light beam 20 emitted by the sample. In this part of the optical path, the excitation light beam 10 is collimated. The optical retarder 28 has an optical retardance and is oriented so as to modify the polarization state of the excitation light beam 10 incident on the sample 5.

In a first example, the optical retarder 28 comprises a half-wave plate, at the wavelength of the excitation light beam 10. The half-wave plate is oriented at 45 degrees from the linear polarization axis of the excitation light beam, to rotate the polarization direction of the excitation light beam 10 by 90 degrees and transform a parallel linear polarization into a perpendicular linear polarization, and vice versa. As an alternative, the half-wave plate is oriented at an angle theta of between 0 and 45 degrees relative to the linear polarization axis of the excitation light beam, to rotate the polarization direction of the excitation light beam 10 by a double angle (2×theta).

In a second example, the optical retarder 28 comprises a Fresnel rhombohedron of half-wave retardance (or lambda/2) and orientable at an angle theta of between 0 and 45 degrees relative to the linear polarization axis of the excitation light beam.

In a third example, the optical retarder 28 comprises a half-wave plate, at the wavelength lambda of the excitation light beam 10. This quarter-wave plate is oriented at a fixed angle of ±45 degrees relative to the linear polarization axis of the excitation light beam, to transform the linear polarization state of the excitation light beam 10 into a right-hand or left-hand circular polarization state on the sample.

In another example, the optical retarder 28 comprises a birefringent plate having a retardance that is adjustable and/or orientable relative to the plane of incidence on the sample. According to another example, the optical retarder 28 comprises a pixelated optical retarder having a spatially adjustable retardance.

The optical retardance 28 is thus arranged on a collimated part of the path of the emitted light beam 20. The optical retarder 28 enables to carry out the reciprocal polarization transformation to the transformation carried out on the laser polarization. By reciprocity, the optical retarder 28 enables to transform the polarization state of the emitted light beam 20 emitted by the sample into a polarization state that is maintained by the transportation via the mirror 3 and the filter 6, up to the polarization splitter and modifier optical device 16.

It is useful to take into account an imperfect optical retarder 28. Indeed, there exist optical retarders 28 having a quarter-wave or half-wave retardance that are perfect at a given wavelength. However, these properties are generally only approximative over an extended wavelength range. Now, according to the present disclosure, the optical retarder 28 operates both at the laser wavelength and at the Raman, respectively PL or fluorescence, wavelengths, which are different. Moreover, a number of Raman microscopes have several lasers at different wavelengths.

The optical retarder 28 in the common path is chosen so as to have an optical retardance (for example, half-wave or quarter-wave) that is relatively stable in wavelength, from the laser wavelength to the highest wavelength usually observed in Raman or PL or fluorescence microscopy. For example, if the laser used emits at the wavelength of 532 nm, and that the useful Raman spectrometer extends up to 650 nm, a wave plate whose optical retardance is optimum around the central wavelength of 585 nm is chosen.

In certain applications, it can be useful to observe the Raman response to excitations in more complex polarizations than linear or circular. The present disclosure provides to place a spatially inhomogeneous optical retarder 28 in the common path. Such a non-uniform optical retarder 28 is, for example, consisted of a pixelated retarder, or also a vortex-type retarder. The use of such a spatially inhomogeneous optical retarder 28 makes it possible to measure the Raman response according to the excitation mode and orthogonal to the excitation mode, in a single operation.

The apparatus 100 makes it possible to control the optical retarder 28, to carry out a range of user-selectable measurements.

In this way, the user can perform angularly resolved measurements in linear polarization, by placing a half-wave plate 28 in the common path, and by acquiring spectrum measurements as a function of the orientation of the half-wave plate.

These results can be represented as polar diagrams at different wavelengths. They can also be represented as the degree-of-polarization spectrum, i.e. the intensity according to a polarization divided by the sum of the intensities relative to the two orthogonal polarizations detected. As an alternative, the results can be represented as a ratio between the intensities relating to the two orthogonal polarizations detected.

In another use, the user can carry out measurements in circular polarization by placing a quarter-wave plate 28 in the common path, and by measuring the two spectra corresponding to the right-hand and left-hand circular polarizations. These results can be represented as a ratio between the two spectra relating to crossed-polarization to co-polarization.

Obviously, various other modifications can be made to the invention within the scope of the appended claims.

1. A Raman or photoluminescence or fluorescence spectrometry apparatus (100) comprising a light source (1) adapted to generate an excitation light beam (10) incident on a sample (5), an optical system (3, 4, 6, 7) to collect and direct a light beam (20) emitted by the sample towards an input (8) of a spectrometer, the spectrometer (9) comprising at least one diffraction grating (12) and a detection system (13), wherein the apparatus comprises a polarization splitter and modifier optical device (16) comprising a polarization splitter (18) and a compensator (17), the optical device (16) being located on a path of the emitted light beam (20) out of the path of the excitation light beam (10), the optical device (16) being configured and oriented to split the emitted light beam (20) incident on the diffraction grating (12) into a first part (21) of the emitted light beam polarized according to a first polarization state and a second part (22) of the emitted light beam polarized according to a second polarization state, the second polarization state being orthogonal to the first polarization state, said first and second polarization states being chosen among polarization states having a component S1 of their Stokes vector less than or equal to 0.2 in absolute value and the detection system (13) being adapted to receive, on a first detection area (14), a spectrum of the first part (21) of the emitted light beam polarized according to the first polarization state and simultaneously, on an second detection area (15), a spectrum of the second part (22) of the emitted light beam polarized according to the second polarization state, the first area (14) and the second area (15) being separated along a direction transverse to a direction of spectral diffraction on the detection system (13).

2. The apparatus according to claim 1, wherein the polarization splitter (18) is located on the path of the emitted light beam downstream from the compensator (17).

3. The apparatus according to claim 1, wherein the polarization splitter (18) is located on the path of the emitted light beam upstream from the compensator (17) and the compensator (17) has a Mueller matrix having an element M1,1 less than 0.2 in absolute value over a spectral range of detection.

4. The apparatus according to claim 1, wherein the polarization splitter (18) is adapted to laterally split the emitted light beam (20) to form the first part (21) of the emitted light beam and, respectively, the second part (22) of the emitted light beam.

5. The apparatus according to claim 4, wherein the polarization splitter (18) comprises a birefringent plate or a Savart plate (18-1, 18-2).

6. The apparatus according to claim 1, wherein the polarization splitter (18) is adapted to laterally split the emitted light beam (20) to form the first part (21) of the emitted light beam and, respectively, the second part (22) of the emitted light beam.

7. The apparatus according to claim 6, wherein the polarization splitter (18) comprises a Wollaston prism, a Rochon prism or a Nomarski prism.

8. The apparatus according to claim 1, wherein the compensator (17) comprises a half-wave plate oriented so that said first polarization state is linear inclined at −45 degrees relative to the diffraction grating (12) lines and the second linear polarization state inclined at +45 degrees relative to the diffraction grating (12) lines, or wherein the compensator (17) comprises a quarter-wave plate oriented so that said first polarization state is right-hand circular and the second polarisation state is left-hand circular or wherein the compensator (17) comprises a Fresnel rhombohedron.

9. The apparatus according to claim 1, wherein the compensator (17) has an achromatic retardance on the spectrum of the first part (21) of the emitted light beam, and respectively on the spectrum of the second part (22) of the emitted light beam.

10. The apparatus according to claim 1, wherein the polarization splitter and modifier optical device (16) is located in the spectrometer (9) between the spectrometer input (8) and the at least one diffraction grating (12), or wherein the polarization splitter and modifier optical device (16) is located in a converging part of the emitted light beam (20) upstream from the spectrometer input or wherein the polarization splitter (18) is located in a collimated part of the emitted light beam (20) upstream from the spectrometer input and wherein the compensator (17) is located downstream from the polarization splitter (18), the compensator (17) being located between the last optical component liable to modify the polarization of the emitted light beam on the collimated path and the diffraction grating (12).

11. The apparatus according to claim 1, wherein the polarization splitter and modifier optical device (16) can be retracted out of the emitted light beam and wherein the apparatus (100) comprises an optical component adapted to be inserted on the path of the emitted light beam to compensate for a defocusing of the emitted light beam at the input of the spectrometer (9) or on the detection system (13) of the spectrometer (9), when the polarization splitter and modifier optical device (16) is retracted.

12. The apparatus according to claim 1, comprising an optical retarder (28) placed on a path that is common to the emitted light beam (20) and the excitation light beam (10), the optical retarder (28) having an optical retardance and being oriented so as to adjust at least one polarization state of the excitation light beam (10) incident on the sample.

13. The apparatus according to claim 12, wherein the optical retarder (28) comprises a quarter-wave plate, a half-wave plate, a Fresnel rhombohedron, a birefringent plate having an adjustable retardance or a pixelated optical retarder having a spatially adjustable retardance.

14. The apparatus according to claim 1, comprising a calculator (30) adapted to calculate a degree of polarization as a function of the spectrum of the first part (21) of the emitted light beam polarized according to the first polarization state and of the spectrum of the second part (22) of the emitted light beam polarized according to the second polarization state.

15. A Raman or photoluminescence or fluorescence spectrometry method comprising the following steps:
generating and directing an incident excitation light beam (10) on a sample (5),
collecting and directing a light beam (20) emitted by the sample (5) to an input (8) of a spectrometer (9) comprising at least one diffraction grating (12) and a detection system (13),
splitting and modifying the polarization of the emitted light beam (20) on an optical path out of the path of the excitation light beam (10), so as to split the emitted light beam (20) incident on the diffraction grating into a first part (21) of the emitted light beam polarized according to a first polarization state and a second part (22) of the emitted light beam polarized according to a second polarization state, the second polarization state being orthogonal to the first polarization state, said first and second polarization states being chosen among polarization states having a component S1 of their Stokes vector less than or equal to 0.2 in absolute value and
acquiring, on a first detection area (14) of the detection system (13), a spectrum of the first part (21) of the emitted light beam polarized according to the first polarization state and simultaneously acquiring, on an second detection area (15), a spectrum of the second part (22) of the emitted light beam polarized according to the second polarization state, the first area (14) and the second area (15) being separated along a direction transverse to a direction of spectral diffraction on the detection system (13).

16. The apparatus according to claim 2, wherein the polarization splitter (18) is adapted to laterally split the emitted light beam (20) to form the first part (21) of the emitted light beam and, respectively, the second part (22) of the emitted light beam.

17. The apparatus according to claim 3, wherein the polarization splitter (18) is adapted to laterally split the emitted light beam (20) to form the first part (21) of the emitted light beam and, respectively, the second part (22) of the emitted light beam.

18. The apparatus according to claim 2, wherein the polarization splitter (18) is adapted to laterally split the emitted light beam (20) to form the first part (21) of the emitted light beam and, respectively, the second part (22) of the emitted light beam.

19. The apparatus according to claim 3, wherein the polarization splitter (18) is adapted to laterally split the emitted light beam (20) to form the first part (21) of the emitted light beam and, respectively, the second part (22) of the emitted light beam.

20. The apparatus according to claim 2, wherein the compensator (17) comprises a half-wave plate oriented so that said first polarization state is linear inclined at −45 degrees relative to the diffraction grating (12) lines and the second linear polarization state inclined at +45 degrees relative to the diffraction grating (12) lines, or wherein the compensator (17) comprises a quarter-wave plate oriented so that said first polarization state is right-hand circular and the second polarisation state is left-hand circular or wherein the compensator (17) comprises a Fresnel rhombohedron.
